(19) United States
(12) Patent Application Publication
(10) Pub. No.: US 2026/0096686 A1
(43) Pub. Date: Apr. 9, 2026

(54) Device And Method For A Cup Steamer

(71) Applicant: Kevin J. Para, New Smyrna Beach, FL (US)

(72) Inventor: Kevin J. Para, New Smyrna Beach, FL (US)

(21) Appl. No.: 18/907,389

(22) Filed: Oct. 4, 2024

(51) Int. Cl. A47J 36/24; A47J 29/02

(52) U.S. Cl. CPC A47J 36/24; A47J 29/02

(57) ABSTRACT

The invention presents an innovative device and system for steaming cups, ingeniously leveraging a multiple egg cooker's functionality. It introduces an adaptable device placed over the egg cooker's egg-holding plate, allowing cups to be steamed before serving hot beverages. This adapter, distinguished by its adjustable height and diameter, features a horizontal surface designed to hold one or more cups above the cooker's water heating reservoir. Notable innovations include central openings for optimal steam distribution and vertical ridges for cup support and efficient condensation management. Crafted from materials such as flexible, heat-resistant silicone rubber or transparent, heat-resistant plastics, the adapter is compatible with standard multiple egg cookers, requiring no alterations. This invention solves the common problem of beverages cooling when poured into cold cups, offering a practical, hygienic, and user-friendly solution to preserve the temperature and quality of hot drinks, enhancing the enjoyment of their consumption.

### RELATED APPLICATIONS

This application claims priority to U.S. Provisional Patent Application No. 63/588,677 , filed on Oct. 6, 2023 and U.S. Provisional Patent Application No. 63/556,269 , filed on Feb. 21, 2024 which is incorporated herein by reference in its entirety, including any addendums, appendixes, and attachments thereto, to the extent these applications do not conflict with the present disclosure herein.

### FIELD OF INVENTION

This invention relates to a device and method to steam a cup prior to adding hot beverages.

### BACKGROUND

The following discussion is not to be deemed admitted prior art, but merely related art to show possible background and information related to devices and methods for steaming a cup.

Cups, as used herein, may include but not limited to, a cup, mug, thermos, tankard, glass, stein, flagon, pot, jug, beaker, seidel, stoop, coffee cup, coffee mug, teacup, and/or espresso cup.

To illustrate examples of potential embodiments without limiting their scope, the following description will discuss the use of the method to heat a cup.

The taste of hot beverages like coffee and tea are significantly affected by the brewing process time and temperature. When the brewing process is completed, pouring the brewed hot beverage into a cold cup creates a lukewarm beverage that is unacceptable especially in colder climates.

Trying to fix this problem by increasing the temperature of the beverage after it has been brewed doesn't work because it alters the flavor in a way that is unacceptable. The conventional method used to overcome the problem is to heat the cup with steam prior to filling the cup with the brewed hot beverage by using a steam hose in a commercial kitchen. The steam also provides a natural way of regulating the temperature since the temperature at which liquid water changes into steam or condenses back into water is nearly constant (varying slightly depending on altitude/atmospheric pressure).

Cups come in varying sizes.

Prior Art includes the following:

Other solutions involve a commercial kitchen steam hose. A significant disadvantage of this solution is that it's not useful or readily available outside a commercial setting.

Other solutions involve heating an empty cup in a microwave oven. A significant disadvantage of this solution is that there's no temperature control and the heat distribution is inconsistent with the objective as the thinner surfaces and edges of the cup heat rapidly and can cause burns or injury to the hands or mouth.

Other solutions involve overheating the beverage itself. A significant disadvantage of this solution is that it significantly compromises the taste.

Other solutions involve using hot water to heat the cup (“scalding”). Some significant disadvantages of this method include a waste of energy and water, more time spent, and more work required.

Each of these methods fail to meet the needed solution because they are not readily available, they don't produce the desired result, they are inefficient and laborious, unreliable, or are limited to cups of a certain size.

Therefore, a need exists for a novel device and method to steam cups.

### BRIEF SUMMARY OF THE INVENTION

This invention relates to a device and method to steam cups that is an improvement to a multiple egg cooker in that it provides a convenient and efficient way for an individual to steam a beverage cup prior to filling the cup with a hot beverage.

The cup illustrated in the drawings is only representative of a typical cup and is not intended to be limited to any style or design of cup.

Numerous aspects of a unique device and method to steam cups are disclosed.

To make the device so that it can be used safely, it is necessary to heat the cup body while only minimally heating the handle of the cup. It is also necessary that the device be compatible with the multiple egg cooker egg holder plate. It is also desirable that accidentally knocking the cup off the cup steamer is difficult. It is also desirable that the device operates in a timely manner so that the cup will be heated at approximately the same time a beverage brewer is able to finish making a cup of hot beverage. It is furthermore desirable that the cup be heated in a sanitary environment. It is furthermore desirable that the device does not limit the height of the cup to be heated.

The disclosed invention advantageously fills all these needs and addresses the aforementioned deficiencies by providing a low cost, energy and time efficient solution to provide a device and method to steam cups.

This invention consists of a steam directing and condensation draining adapter device 002 to be used for an individual cup that makes it possible to steam an individual beverage cup using this invention in combination with the lower heating portion of a conventional multiple egg cooker. The disclosed device to steam a cup is unique when compared to other known devices because it provides (1) heating of the cup in a short period of time, (2) heating the cup while minimally heating the handle and lip of the cup, (3) does not need to be assembled to or require modification of a multiple egg cooker, (4) a safe and sanitary way to heat a beverage cup, (5) a high friction surface that makes it difficult to accidentally bump the cup off the cup steamer.

A conventional multiple egg cooker as used herein may be, but is not limited to, egg cookers as sold in stores like Walmart or Kohl's, for example, under names like “My Mini” and “Progress.”

### BRIEF DESCRIPTION OF THE DRAWINGS

A device and method to steam cups is illustrated by way of example, and not by way of limitation, in the figures of the accompanying drawings.

While aspects of a device and method to steam cups will be described with reference to the details of the embodiments of the invention shown in the drawings (and some embodiments not shown in the drawings), these details are not intended to limit the scope of the invention.

FIG. 1A. An exploded perspective view of a device and method to steam cups.

FIG. 1B. An assembled perspective view of a device and method to steam cups.

FIG. 2A. An assembled perspective view of a device and method to steam cups with a hypothetical cup in place for steaming.

FIG. 2B. An assembled perspective view of a device and method to steam cups with a hypothetical cup in place for steaming.

FIG. 3. An isometric view of a device and method to steam cups.

FIG. 4. A top view of a device and method to steam cups.

FIG. 5. A front view of a device and method to steam cups.

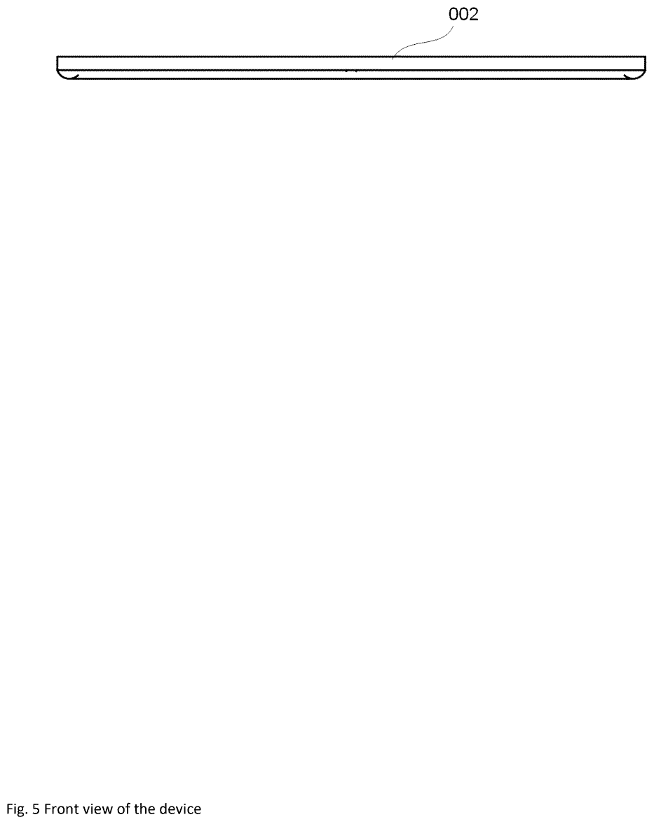

FIG. 6A. A section A-A view of a device and method to steam cups.

FIG. 6B. A section view A-A of a device and method to steam cups.

FIG. 7A. A section B-B view of a device and method to steam cups.

FIG. 7B. A section view B-B of a device and method to steam cups.

### List of Drawing Reference Numbers

000 A device and method to steam cups
001 A Cup
002 An adapter device 002 (Cup supporting and steam directing and condensation draining plate)
003 A multiple egg cooker base
004 A multiple egg holding plate
005 A multiple egg cooker heating surface
006 A multiple egg cooker water reservoir
007 A multiple egg cooker start button
008 A device center hole
009 A device ridges
010 A device sloping edge

### DETAILED DESCRIPTION

The order of the steps in the disclosed processes may be altered within the scope of the invention.

In conjunction with the accompanying drawings, the following detailed description provides a more specific and detailed explanation of various embodiments of a device and method to steam cups. These embodiments are provided to illustrate the invention but should not be seen as limiting its scope; the invention can be embodied in many different forms and is intended to be thorough and comprehensive to those skilled in the art.

For the purposes of promoting an understanding of the principles of a device and method to steam cups, reference will now be made to the embodiments illustrated in the drawings and specific language will be used to describe the same, only as examples and not intended to be limiting.

A cup may come in varying sizes and shapes, including but not limited to round, square, rectangle, oval, hexagon, octagon, and irregular shapes.

A cup may be made of various materials, including but not limited to ceramic, glass, steel, porcelain.

Disclosed is a device and method to steam cups, comprising of the following components: (1) a commercially available egg cooker; (2) an adapter device 002.

These components, generally speaking, are configured as follows: (1) a commercially available egg cooker has an adapter device 002 placed on its top, (2) a cup is placed upside down on the adapter device 002.

Some embodiments of a device and method to steam cups may also have one or more of the following: (1) Strategically placed center hole in the adapter device 002, (2) at series of raised ribs, (3) a condensate ring or shoulder, (4) high friction surface material.

The disclosed device and method to steam cups is unique when compared with other known devices and solutions because it provides: (1) for easy one-handed operation; (2) is reusable; (3) has no modification requirements to a commercially purchased device, (4) is rugged and durable with potential for longevity.

The disclosed device and method to steam cups is unique in that it is structurally different from other known devices or solutions. More specifically, the device is unique due to the presence of (1) a device adapter 002 assembly of a size that can be adapted to different egg cookers; (2) made of different materials.

Various embodiments incorporate an adapter within the device and method designed for steaming cups.

The height of the adapter, denoted as device 002, is adjustable within a range that is not intended to be restrictive, extending from less than 1 cm to over 5 cm.

Similarly, the diameter of adapter device 002 is configurable, extending from less than 5 cm to in excess of 16 cm, with this range also not intended to serve as a limitation.

In some embodiments, adapter device 002 is constructed from a flexible, heat-resistant material, such as silicone rubber. This example is provided for illustrative purposes only and does not limit the scope of materials that may be used.

In additional embodiments, adapter device 002 is fabricated from a heat-resistant, transparent plastic material, for instance, Styrene acrylonitrile, again provided as an example and not as a restrictive limitation.

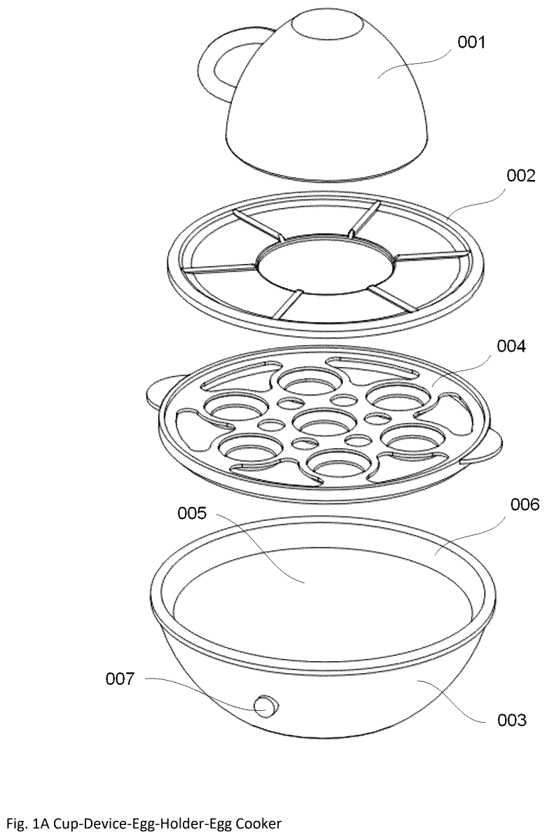

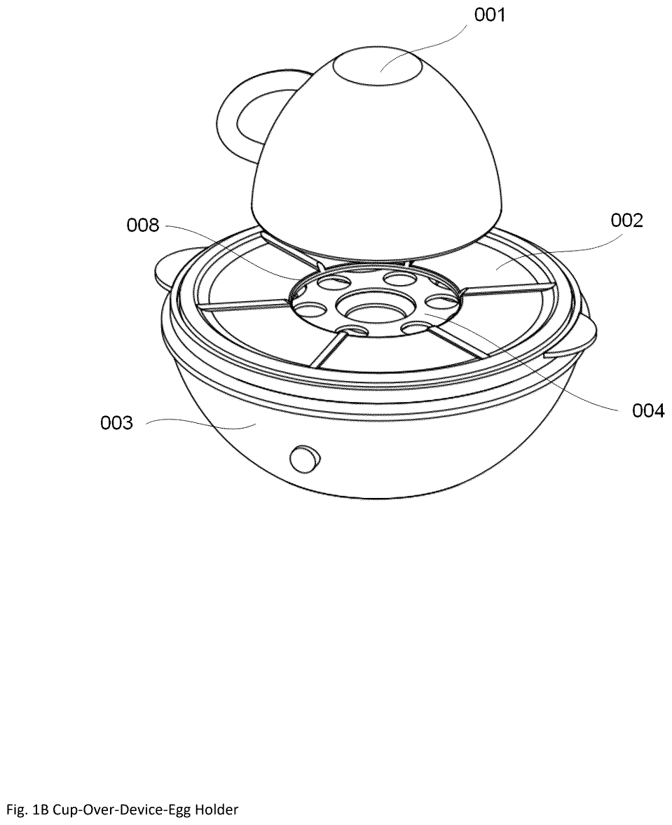

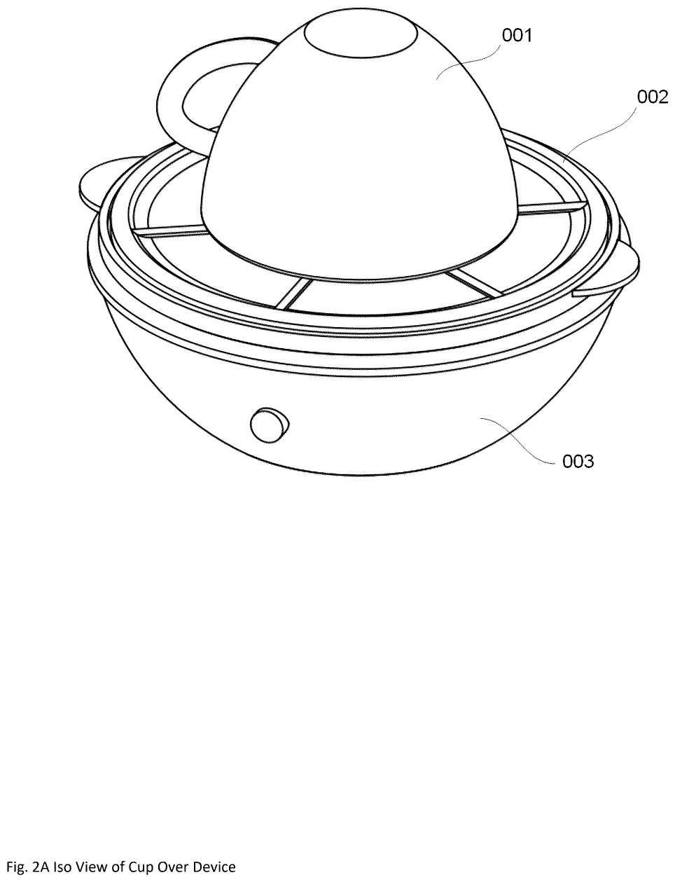

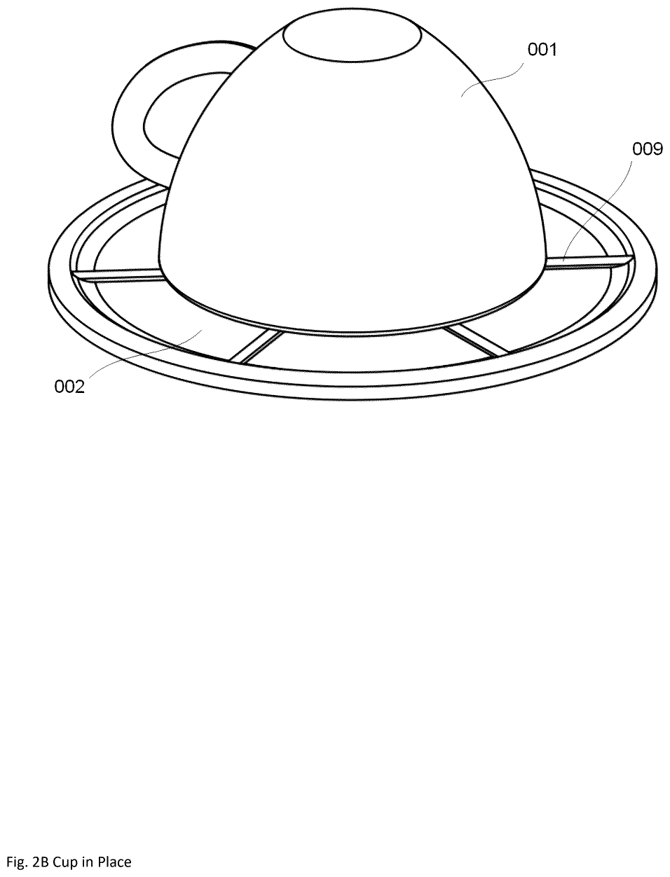

In the preferred embodiment, the device is composed of a cup supporting and steam directing and condensation draining adapter device 002 2 configured to accommodate an individual cup 1 with the cup 1 opening facing downward (see FIG. 1A and FIG. 1B and FIG. 2A and FIG. 2B). The cup steaming process begins by filling the multiple egg cooker heating unit 3 water reservoir 6 with water and then the multiple egg holding plate 4 is placed on top of the multiple egg cooker heating unit base 3 and then adapter device 002 2 is placed on top of the multiple egg cooker plate 4. Next cup 1 is placed on top of adapter device 002 2 and then the start button 7 is pressed to start heating the multiple egg cooker heating surface 5. When the multiple egg cooker base 3 internal timer times out, the cup 1 is warmed up and ready to be used.

In other embodiments the cup 1 may or may not have a handle.

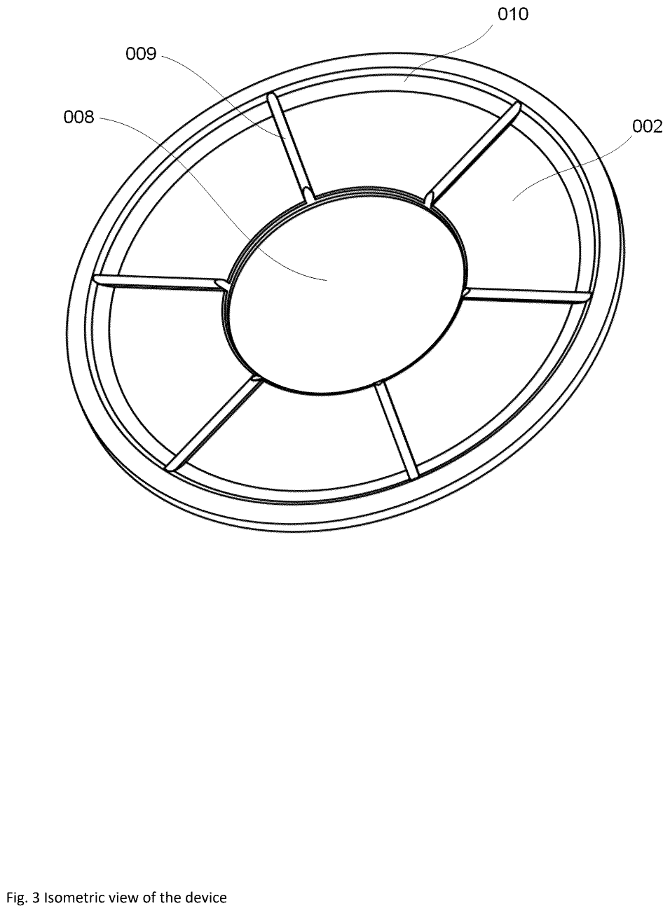

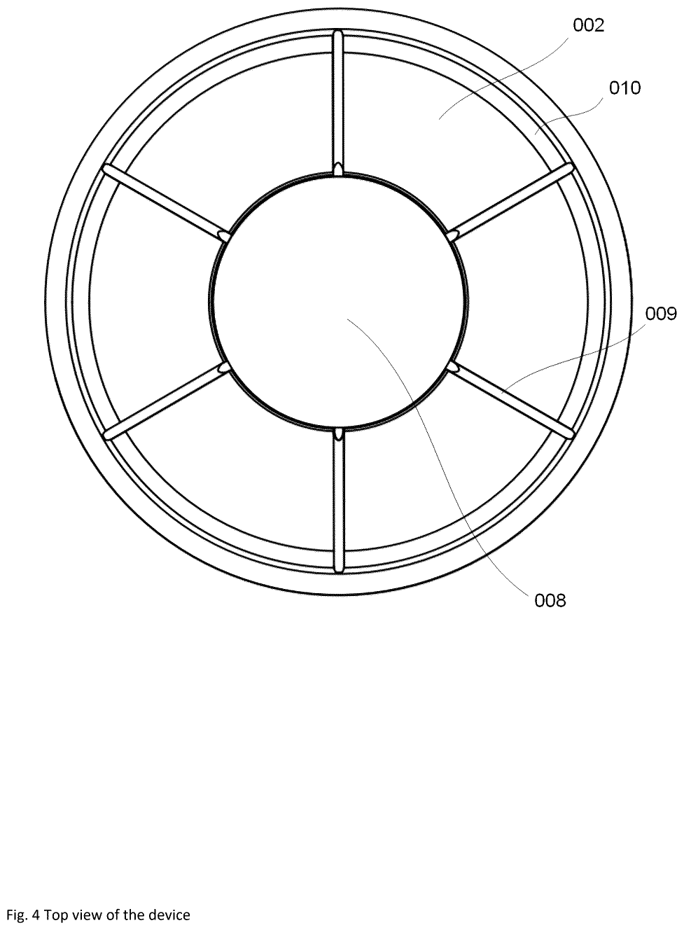

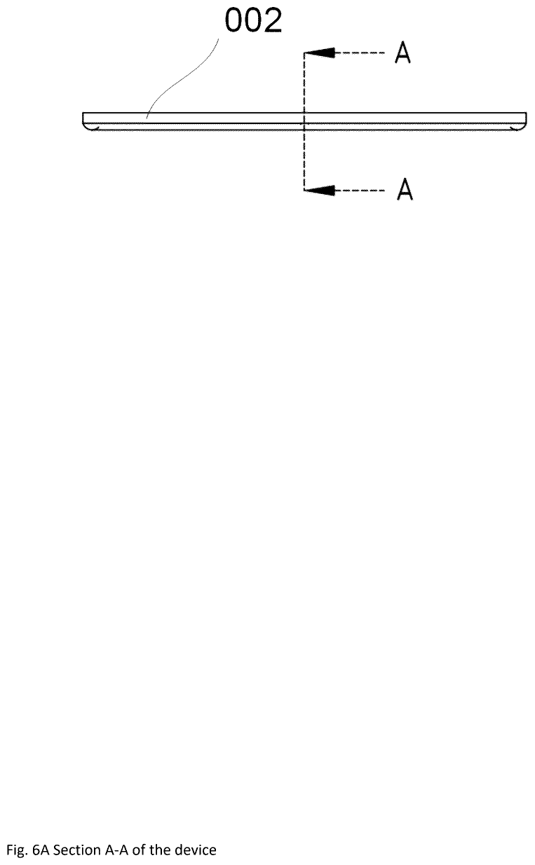

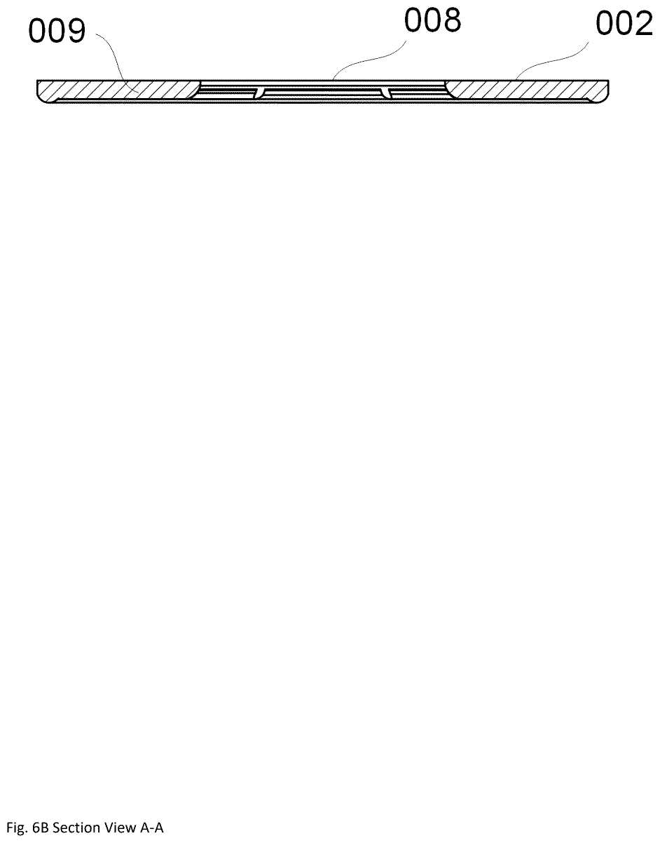

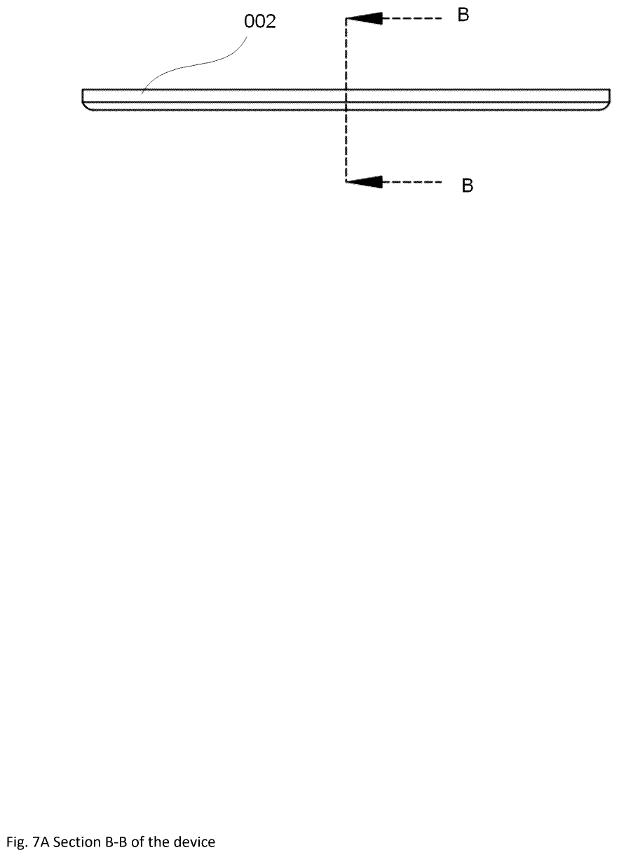

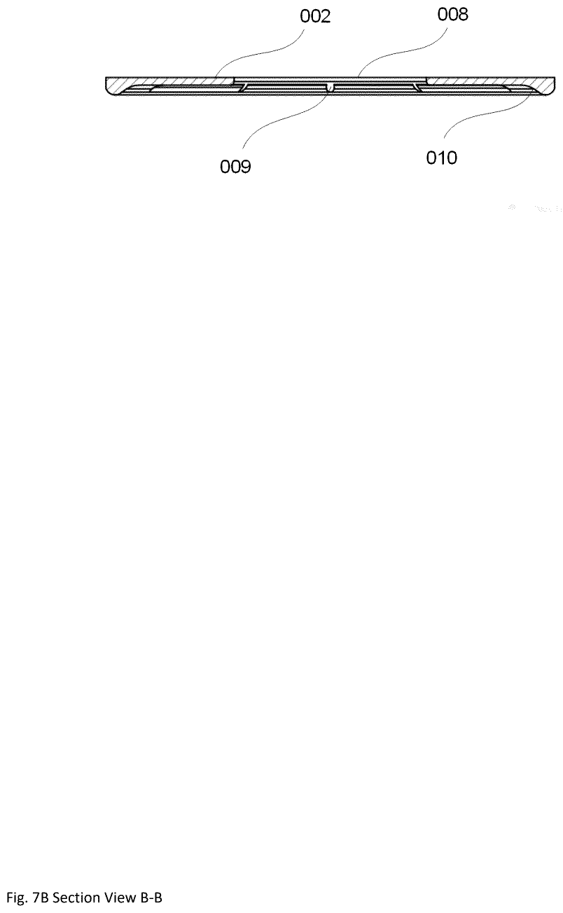

The adapter device 002 2 has a hole at or near the center 8 (see FIG. 1B, FIG. 3, FIG. 4, FIG. 6B, and FIG. 7B) to provide a passageway whereby the steam generated by the multiple egg cooker 3 (from the multiple egg cooker 3 heated water reservoir below 6) rises into the interior of the cup 1 see FIG. 1A and FIG. 1B. The hole 8 at or near the center of adapter device 002 2 (see FIG. 1B) may vary in diameter from less than one half inch to two or more inches and in some embodiments a plurality of holes may be used.

One or more holes 8 of various diameters near the center of adapter device 002 2 may be used in other embodiments to accomplish this purpose.

Adapter device 002 2 has ridges (or fins) 9 (see FIG. 2B and FIG. 4) that may use surface tension and gravity (where cup 1 lip contacts the ridges 9) in various embodiments to direct the condensation on the inside of the cup downward through hole 8 (see FIG. 3, FIG. 4, FIG. 6B and FIG. 7B).

The number of ridges 9 may vary from at least three to more than sixteen. The cross-section of ridges 9 may be tapered so that the bottom width dimension is wider than the top edge dimension wherein the taper may be anywhere from one to more than forty-five degrees. Ridges 9 may be hollow to reduce the overall amount of material needed to make adapter device 002 2 wherein the wall thickness may vary from one half to three mm being open at the bottom and closed at the top. Ridges 9 may have all edges rounded with a radius that may vary from one tenth mm to three mm. Ridges 9 may have tapered vertical walls to facilitate injection molding wherein the taper may vary from less than one degree to more than three degrees.

Versions of a device and method to steam cups may be made individually, in batches, or via continuous assembly.

For instance, to create one possible embodiment of the device and method to steam cups, prepare a suitable work surface and gather all the mentioned components. Assemble the components in a logical order, following the practices of a skilled person in the field. Begin by using a 3-D printer and an appropriate plastic resin to produce an adapter assembly 002 according to the provided model.

An example to use the assembled version of a device and method to steam cups comprises obtaining a suitable multiple egg cooker, and placing the adapter on the egg cooker. Begin operation of the egg cooker and place the cup on the adapter.

Different features, variations and multiple different embodiments have been shown and described with various details. What has been described in this application at times in terms of specific embodiments is done for illustrative purposes only and without the intent to limit or suggest that what has been conceived is only one particular embodiment or specific embodiments. It is to be understood that this disclosure is not limited to any single specific embodiments or enumerated variations. Many modifications, variations and other embodiments will come to mind of those skilled in the art, and which are intended to be and are in fact covered by both this disclosure. It is indeed intended that the scope of this disclosure should be determined by a proper legal interpretation and construction of the disclosure, including equivalents, as understood by those of skill in the art relying upon the complete disclosure present at the time of filing.

The embodiments of a device and method to steam cups may be utilized individually, concurrently, or in any sequential combination.

Those skilled in the art to which this application relates will appreciate that other and further additions, deletions, substitutions and modifications may be made to the described embodiments.

The specification is not to be taken in a limiting sense but is made merely for the purpose of describing the general principles of exemplary embodiments; many additional embodiments of this invention are possible. It is understood that no limitation of the scope of the invention is thereby intended. The scope of the disclosure should be determined with reference to the Claims. Reference throughout this specification to “one embodiment,” “an embodiment,” or similar language means that a particular feature, structure, or characteristic that is described in connection with the embodiment is included in at least one embodiment of the present disclosure. Thus, appearances of the phrases “in one embodiment,” “in an embodiment,” and similar language throughout this specification may, but do not necessarily, all refer to the same embodiment.

The invention is described with such embodiments, but the invention is not limited to any embodiment. The scope of the invention is limited only by the claims and the invention encompasses numerous alternatives, modifications and equivalents. Several specific details are set forth in the description to provide a thorough understanding of the invention. These details are provided for the purpose of example and the invention may be practiced according to the claims without some or all of these specific details. In general, the order of the steps of disclosed processes may be altered within the scope of the invention.

Unless otherwise indicated, the drawings are intended to be read (e.g., arrangement of parts, proportion, degree, etc.) together with the specifications, and are to be considered a portion of the entire written description of this invention. As used in the following description, the terms “horizontal”, “vertical”, “left”, “right”, “up” and “down”, as well as adjectival and adverbial derivatives thereof (e.g., “horizontally”, “rightwardly”, “upwardly”, etc.), simply refer to the orientation of the illustrated structure as the particular drawing figure faces the reader. Similarly, the terms “inwardly” and “outwardly” generally refer to the orientation of a surface relative to its axis of elongation, or axis of rotation, as appropriate. Also, as used herein, terms such as “positioned on” or “supported on” mean positioned or supported on but not necessarily in direct contact with the surface.

What is claimed:

1. A device and method for steaming cups with a multiple egg cooker, comprising:
an adapter device of a given height and diameter;
wherein the multiple egg cooker has a water reservoir;
wherein the adapter device is configured to be positioned atop the multiple egg cooker egg holding plate;
wherein the adapter device includes a horizontal surface designed to support at least one cup over a water heating reservoir assembly of the egg cooker for steaming.

2. The device and method for steaming cups with a multiple egg cooker of claim 1, wherein the horizontal surface comprises one or more openings located substantially at the center to permit the passage of steam from the water heating reservoir to the vicinity of the center of the supported cup.

3. The device and method for steaming cups with a multiple egg cooker of claim 1, wherein the horizontal surface includes a plurality of vertical ridges designed to support the cup and facilitate the drainage of condensation.

4. The device and method for steaming cups with a multiple egg cooker of claim 1, wherein the horizontal surface is fabricated from a flexible, heat-resistant material, including but not limited to silicone rubber.

5. The device and method for steaming cups with a multiple egg cooker of claim 1, wherein the periphery of the horizontal surface is dimensioned to match the contour of the multiple egg cooker's water heating surface beneath it.

6. The device and method for steaming cups with a multiple egg cooker of claim 1, further comprising:
the horizontal surface having a peripheral rim elevated relative to the remainder of the surface, with the peripheral rim with a slope downward towards the apexes of the ridges or the flat areas interspersed among the ridges; and
wherein the slope of the peripheral rim is configured at an angle between more than 15 degrees and less than 75 degrees.

7. The device and method for steaming cups with a multiple egg cooker of claim 1, wherein the horizontal surface is constructed from a transparent, heat-resistant plastic material, including but not limited to Styrene acrylonitrile.

8. A method of steaming a cup with a multiple egg cooker using the device and method for steaming cups with a multiple egg cooker of claim 1, comprising the steps of:
selecting an appropriate multiple egg cooker;
placing the adapter device on the multiple egg cooker;
ensuring the multiple egg cooker has water in a multiple egg cooker reservoir;
placing a cup on the horizontal surface of the adapter device;
turning on the multiple egg cooker to create steam;
leaving the cup on the adapter for an appropriate time to warm the cup to the desired temperature; and
removing the cup for use; thereby warming the cup to receive an appropriate beverage.
